(19) United States
(12) Patent Application Publication
(10) Pub. No.: US 2010/0153373 A1
(43) Pub. Date: Jun. 17, 2010

(54) WEATHER INFORMATION RECEPTION AND OUTPUT DEVICE

(75) Inventors: Gee Beom JIN, Goyang (KR); Jeung Whan LEE, Seoul (KR); Hyuk Jin YUN, Seoul (KR); Bong Soo LEE, Gwangmyeong (KR); Kyung Hwan PARK, Seoul (KR)

Correspondence Address: LRK Patent Law Firm, 1952 Gallows Rd, Suite 200, Vienna, VA, 22182, US

(73) Assignee: KOREA METEOROLOGICAL ADMINISTRATION, Seoul (KR)

(21) Appl. No.: 12/631,242

(22) Filed: Dec. 4, 2009

(30) Foreign Application Priority Data
Dec. 15, 2008 (KR) 10-2008-0127083

(51) Int. Cl. G06F 17/30; G06F 15/16

(52) U.S. Cl. 707/722; 707/783; 709/203; 707/E17.107

(57) ABSTRACT

A weather information reception and output device includes a server access unit accessing a server in a meteorological office and retrieving a database to check if there is a new message to be downloaded; a message download unit downloading the new message after the server access unit retrieves the database; a message output controller receiving a signal from the message download unit and controlling the new message to be output; and a message output unit outputting the message in a recognizable manner under control of the message output controller, wherein the server access unit and the message download to unit retrieve and download the database based on an open architecture. The device can download, in real time, over the Internet, weather forecast and special-news information produced in a universal format, and output the weather forecast and special-news information in visible and audible form based on an open architecture and a SMART alarm. Accordingly, the device can directly access the weather information which is neither compressed nor encrypted and allows those skilled in a corresponding client program to upgrade the client program. Further, the device can store a client program in a built-in memory to prevent access from systems other than a server of a meteorological office. thereby improving system security against viruses, hackers or the like.

### BACKGROUND OF THE INVENTION

1. Field of the Invention

The present invention relates generally to a weather information reception and output device and, more particularly, to a weather information reception and output device which receives weather-related information such as weather forecasts, weather-related special news, earthquakes, and the like from a meteorological office and outputs the weather-related information.

2. Description of the Related Art

A conventional weather forecast system provides viewers with limited weather information, such as temperature, humidity and rainfall probability, through television or radio broadcasting stations only for a predetermined time period, such as news-broadcast time.

In general, data on natural disasters, such as typhoons, floods, heavy rain, storms, tsunamis, blizzards, droughts and earthquakes, is collected using weather satellites. The collected data is then transmitted to emergency alert centers, such as central or local disaster relief centers, or broadcast stations. The emergency alert centers then issue a disaster warning.

A conventional transmitter is configured to transmit compressed or encrypted weather information. Further, only a specific part of reception and output programs of the transmitter can be modified. A meteorological office, which takes the responsibility of producing and providing weather information, cannot offer various types of weather information without upgrading software of interest.

### SUMMARY OF THE INVENTION

The present invention is conceived to solve the problems of the related art and an aspect of the present invention is to provide a weather information reception and output device which is configured to download, in real time, over the Internet, weather forecast and special-news information produced in a universal format, and output the weather forecast and special-news information in visible and audible form based on an open architecture and Self-Monitoring, Analysis, and Reporting Technology (S.M.A.R.T.) alarm which is a weather information output program, so that the device can directly access the weather information, which is neither compressed nor encrypted, and allows those skilled in a corresponding client program to upgrade the client program.

Another aspect of the present invention is to provide a weather information reception and output device which is configured to store a client program in a built-in memory to prevent access from systems other than a server of a meteorological office, thereby improving system security against viruses, hackers or the like.

In accordance with one aspect, a weather information reception and output device includes: a server access unit accessing a server in a meteorological office and retrieving a database to check if there is a new message to be downloaded; a message download unit downloading the new message after the server access unit retrieves the database; a message output controller receiving a signal from the message download unit and controlling the new message to be output; and a message output unit outputting the message in a recognizable manner under control of the message output controller, wherein the server access unit and the message download unit retrieve and download the database based on an open architecture.

The server access unit, the message download unit, the message output controller and the message output unit may be integrated into a set-top box.

The message output unit may include at least one of a warning light, a liquid crystal display (LCD), an electronic bulletin board, a speaker and a printer.

The message output controller may be connected to a built-in memory that stores an application program allowing access only to a specific server.

### BRIEF DESCRIPTION OF THE DRAWINGS

The above and other aspects, features and advantages of the invention will become apparent from the following detailed description in conjunction with the accompanying drawings, in which:

FIG. 1 is a schematic diagram of a weather information reception and output device in accordance with one embodiment of the present invention; and

FIG. 2 is a block diagram of the weather information reception and output device in accordance with the embodiment of the present invention.

### DETAILED DESCRIPTION OF THE EMBODIMENTS

Embodiments of the invention will now be described with reference to the accompanying drawings.

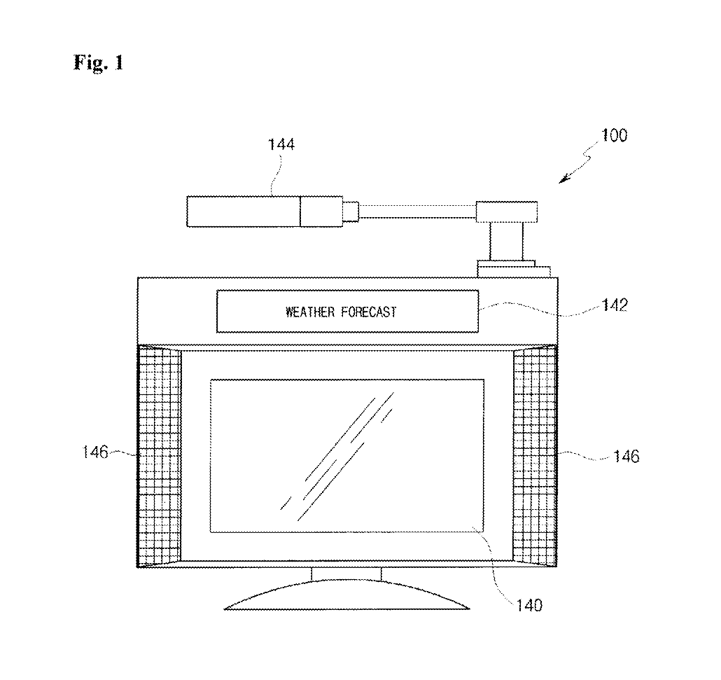

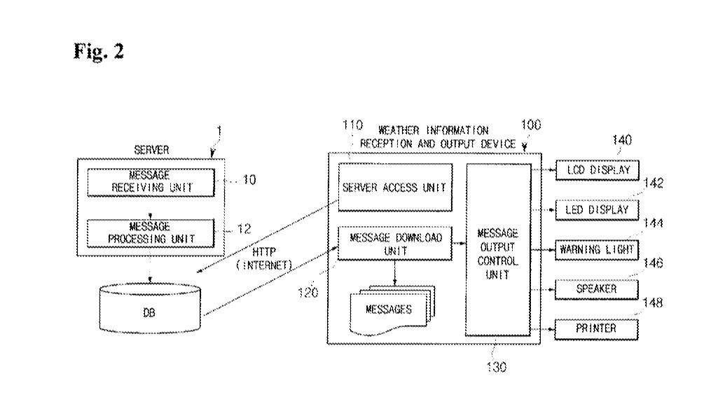

Referring to FIGS. 1 and 2, a weather information reception and output device 100 according to one embodiment includes a server access unit 110, a message download unit 120, a message output controller 130 and a message output unit.

A server 1 in a meteorological office provides messages to the weather information reception and output device 100. The server 1 includes a message receiving unit 10 and a message processing unit 12. The message receiving unit 10 receives messages about weather forecast and special-news information. The message processing unit 12 forms a database of the weather forecast and special-news information which is to be provided when the server access unit 110 accesses the server 1.

The server access unit 110, the message download unit 120, the message output controller 130, and the message output unit may be integrated into a set-top box. The server access unit 110 accesses the server 1 in a meteorological office over the Internet at regular intervals using a client program stored in the message output controller 130 to inquire of the server 1 whether there is any message about weather forecast or special-news information.

If the server access unit 110 finds any new message about weather forecast or special-news information in the database in the server 1, the message download unit 120 downloads the message from the server 1 and processes the message.

The server access unit 110 and the message download unit 120 retrieve and download the database through an open architecture for the Internet (which is MS-based and HTTP-based) which allows potential users skilled in the client program to upgrade components without any proprietary constraints.

Specifically, HTTP-based polling is adopted as a message transport protocol, which will not lay a burden on the server 1 even though a number of users access the server 1 through the Internet's open architecture to retrieve and download the database. Furthermore, since various functionalities may be easily added using the open architecture for outputting an unencrypted, universal format of messages, Self-Monitoring, Analysis, and Reporting Technology (S.M.A.R.T.) alarm program is applied which may be consistently developed.

The message may be configured to be downloaded upon direct access without any compression or encryption of the message so that the message may be viewed with a universal viewer.

The message output controller 130 receives a signal from the message download unit 120 and controls the message output unit to output new messages.

An application program as a client program is stored in a built-in universal serial bus (USB) memory (not shown), which is connected to the message output controller 130, to protect systems other than the server 1 from accessing the weather information reception and output device 100. Accordingly, it is possible to improve system security against viruses, hackers or the like.

Furthermore, a USB port (not shown) may be connected to the message output controller 130 so that additional output devices other than the message output unit may be provided for various business environments.

The message output unit is operated under control of the message output controller 130. Examples of the message output unit may include a liquid crystal display (LCD) 140 for displaying messages about weather forecast or special-news information in a visible form, a light-emitting diode (LED) display 142 as an electronic bulletin board for displaying messages about weather forecast or special-news information through LEDs, a warning light 144, a speaker 146, a printer 148 and any other visible or audible devices.

The weather information reception and output device 100 equipped with the message output unit may be integrated into a set-top box where the LCD 140 is provided in the center of the front face of the set-top box, the LED display 142 is provided over the LCD 140, the warning light 144 is provided over the LED display 142, and the speakers 146 are provided on both sides of the LCD 140.

Therefore, the weather information reception and output device 100 is operated as follows.

First, the server access unit 110 accesses the server 1 at regular intervals over the Internet through the client program stored in the message output controller 130 to check if there are messages about weather forecast or special-news information.

If there are new messages about weather forecast or special-news information in the server 1, the message download unit 120 downloads a database corresponding to the messages.

The database about the downloaded weather forecast or special-news information is output by the message output unit including the LCD 140, the LED display 142 as an electronic bulletin board, the warning light 144, and the speakers 146. The database may be output by the printer 148.

As such, in the embodiment of the invention, the weather information reception and output device downloads, in real time, over the Internet, weather forecast and special-news information produced in a universal format, and outputs the weather forecast and special-news information in visible and audible form based on an open architecture and a SMART alarm which is a weather information output program. Accordingly, the device can directly access the weather information, which is neither compressed nor encrypted, and allows those skilled in a corresponding client program to upgrade the client program.

Further, in the embodiment of the invention, the weather information reception and output device stores a client program in a built-in memory to prevent access from systems other than a server of a meteorological office, thereby improving system security against viruses, hackers or the like.

Although some embodiments have been provided to illustrate the invention in conjunction with the drawings, it will be apparent to those skilled in the art that the embodiments are given by way of illustration only, and that various modifications and variations can be made without departing from the spirit and scope of the invention. The scope of the invention should be limited only by the accompanying claims.

What is claimed is:

1. A weather information reception and output device comprising:
a server access unit accessing a server in a meteorological office and retrieving a database to check if there is a new message to be downloaded;
a message download unit downloading the new message after the server access unit retrieves the database;
a message output controller receiving a signal from the message download unit and controlling the new message to be output; and
a message output unit outputting the message in a recognizable manner under control of the message output controller,
wherein the server access unit and the message download unit retrieve and download the database based on an open architecture.

2. The device according to claim 1, wherein the server access unit, the message download unit, the message output controller and the message output unit are integrated into a set-top box.

3. The device according to claim 1, wherein the message output unit comprises at least one of a warning light, a liquid crystal display (LCD), an electronic bulletin board, a speaker and a printer.

4. The device according to claim 1, wherein the message output controller is connected to a built-in memory that stores an application program allowing access only to a specific server.
